(19) United States
(12) Patent Application Publication
(10) Pub. No.: US 2008/0006739 A1
(43) Pub. Date: Jan. 10, 2008

(54) Vehicle power train including at least two power sources

(76) Inventors: Kazuhiko Mochida, Rancho Palos Verdes, CA (US); Curtis M. Longo, Alta Loma, CA (US); Garrick F. Talavera, Rolling Hills Estates, CA (US); Takao Tate, Shizuoka (JP); Michael K. Maxwell, Long Beach, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/607,854

(22) Filed: Dec. 4, 2006

Related U.S. Application Data
(60) Provisional application No. 60/741,472, filed on Dec. 2, 2005.

(51) Int. Cl. B64D 35/00; F16F 15/00; F16H 37/06

(52) U.S. Cl. 244/60; 267/136; 477/34; 74/665 A

(57) ABSTRACT

A power train for a vehicle may include at least two power sources configured to supply power for propelling the vehicle. Each of the power sources may include a power source output shaft. The power train may further include a transmission including at least two transmission inputs operably coupled to the at least two power source output shafts, and a single transmission output shaft configured to supply power to a propulsion member. The power train may also include a controller configured to control operation of the at least two power sources, and the controller may include a full-authority digital electronic controller (FADEC).

### RELATED APPLICATION

This application claims the benefit of priority under 35 U.S.C. § 119(e) of U.S. Provisional Application No. 60/741,472, filed on Dec. 2, 2005, the disclosure of which is incorporated herein by reference.

### FIELD OF THE DISCLOSURE

The present disclosure relates to power trains and methods for supplying power to propulsion members. In particular, the present disclosure relates to vehicle power trains and methods for supplying power to vehicle propulsion members.

### BACKGROUND

It is often desirable to provide power to systems in a flexible and efficient manner. For example, it is often desirable to supply power to a vehicle such that the amount of power available to operate the vehicle can meet a wide variety of power demands. For example, it may be desirable to supply power to a vehicle such that the vehicle has sufficient power to meet peak power demands while still operating efficiently when peak power is not desired. Further, it may also be desirable to supply power to the vehicle in a manner that results in safe operation of the vehicle.

Air vehicles are an example of vehicles for which it may be desirable to supply power in a flexible manner. For example, it may be desirable for an air vehicle to have a power train that is capable of supplying a relatively high amount of peak power during certain operations, while also being capable of efficiently supplying relatively reduced amounts of power during other operations. When an air vehicle such as, for example, a fixed-wing airplane or a rotary-wing aircraft, takes off, the air vehicle may generally need a relatively greater supply of power to provide sufficient speed and/or lift for propelling the air vehicle aloft. Further, the air vehicle may need a relatively greater supply of power in order to achieve a desired speed and/or altitude. Once the desired speed and/or altitude has been achieved, however, the air vehicle may require less power in order to maintain the desired speed and/or altitude. In such circumstances, it may be desirable to supply the relatively reduced amount of desired power in an efficient manner.

In addition to a flexible power supply, it may be desirable to supply power to a vehicle in a reliable manner. For example, for an air vehicle, it may be desirable to have two or more power sources, such that in the event that one power source is compromised or fails, another power source may supply sufficient power to continue safe operation of the air vehicle. Further, it may be desirable to provide a power train with a control system for operating two or more power sources that is relatively less complex for an operator to operate than simultaneous operation of two or more separate power sources having a corresponding number of controls. Such a control system may result in an operating procedure that permits less-experienced operators or operators of lower skill level to operate a vehicle, such as, for example, an airplane, having more than one power source.

The invention may seek to satisfy one or more of the above-mentioned desires. Although the present invention may obviate one or more of the above-mentioned desires, it should be understood that some aspects of the invention might not necessarily obviate them.

### SUMMARY

In the following description, certain aspects and embodiments will become evident. It should be understood that the invention, in its broadest sense, could be practiced without having one or more features of these aspects and embodiments. It should be understood that these aspects and embodiments are merely exemplary.

One aspect of the invention relates to a power train for a vehicle. The power train may include at least two power sources configured to supply power for propelling the vehicle. Each of the power sources may include a power source output shaft. The power train may further include a transmission including at least two transmission inputs operably coupled to the at least two power source output shafts, and a single transmission output shaft configured to supply power to a propulsion member. The power train may also include a controller configured to control operation of the at least two power sources, and the controller may include a full-authority digital electronic controller (FADEC).

According to another aspect, a power train for a vehicle may include at least two power sources operably coupled to one another to form a unitary structure. The at least two power sources may be configured to supply power for propelling the vehicle. Each of the power sources may include a power source output shaft and a plurality of cylinders. The power train may further include a transmission including at least two transmission inputs operably coupled to the at least two power source output shafts, and a single transmission output shaft configured to supply power to a propulsion member. The transmission may be configured to combine power supplied by the at least two power sources via the power source output shafts into the single transmission output shaft. The power train may also include a propulsion member configured to propel the vehicle. Each of the power source output shafts may define a longitudinal axis, and each of the power sources may define a respective plane of symmetry with respect to the respective cylinders of each power source. Each of the power sources may define a respective second plane that includes the longitudinal axis and extends in a direction perpendicular to the first plane, and at least at least one of (1) the first plane defined by one of the power sources is coplanar with the first plane defined by another of the power sources, (2) the first plane defined by one of the power sources intersects the first plane defined by another of the power sources, and (3) the second plane defined by one of the power sources and the second plane defined by another of the power sources are parallel and spaced from one another.

According to yet another aspect, a vehicle may include a propulsion member and a power train. The power train may include at least two power sources. The at least two power sources may be configured to supply power for propelling the vehicle. Each of the power sources may include a power source output shaft and a transmission including at least two transmission inputs operably coupled to the at least two power source output shafts, and a single transmission output shaft operably coupled to the propulsion member and configured to supply power to a propulsion member. The transmission may be configured to combine power supplied by the at least two power sources via the power source output shafts into the single transmission output shaft. The power train may further include a controller configured to control operation of the at least two power sources. The controller may include a full-authority digital electronic controller (FADEC).

Additional objects and advantages of the invention will be set forth in part in the description which follows, and in part will be obvious from the description, or may be learned by practice of the invention.

It is to be understood that both the foregoing general description and the following detailed description are exemplary and explanatory only and are not restrictive of the invention, as claimed.

Aside from the structural and procedural arrangements set forth above, the invention could include a number of other arrangements such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 is a perspective view of an exemplary vehicle, including an exemplary embodiment a power train;

FIG. 2 is a perspective view of an exemplary vehicle, including an exemplary embodiment of a power train;

FIG. 3 is a perspective view of an exemplary vehicle, including an exemplary embodiment of a power train;

FIG. 4 is a schematic, partial section view of an exemplary embodiment of a power train;

FIG. 5A is a schematic, perspective section view of an exemplary embodiment of a power source;

FIG. 5B is a schematic, perspective section view of another exemplary embodiment of a power source;

FIG. 5C is a schematic, perspective section view of a further exemplary embodiment of a power source;

FIG. 6 is a schematic, partial section view of another exemplary embodiment of a power train;

FIG. 7A is a schematic, partial section view of a further exemplary embodiment of a power train;

FIG. 7B is a schematic, partial section view of another exemplary embodiment of a power train;

FIG. 8A is a schematic, partial plan view of an exemplary embodiment of a power train in an exemplary vehicle;

FIG. 8B is a schematic, partial plan view of another exemplary embodiment of a power train in an exemplary vehicle;

FIG. 8C is a schematic, partial plan view of a further exemplary embodiment of a power train in an exemplary vehicle;

FIG. 9A is a schematic plan view of an exemplary embodiment of a power train;

FIG. 9B is a schematic plan view of another exemplary embodiment of a power train;

FIG. 9C is a schematic plan view of a further exemplary embodiment of a power train;

FIG. 9D is a schematic plan view of another exemplary embodiment of a power train;

FIG. 9E is a schematic plan view of a further exemplary embodiment of a power train;

FIG. 9F is a schematic plan view of another exemplary embodiment of a power train;

FIG. 10 is a schematic, partial plan view of an exemplary embodiment of a power train; and

FIG. 11 is schematic, partial plan view of an exemplary embodiment of a power train.

### DESCRIPTION OF EXEMPLARY EMBODIMENTS

Reference will now be made in detail to exemplary embodiments of the invention. Wherever possible, the same reference numbers are used in the drawings and the description to refer to the same or like parts.

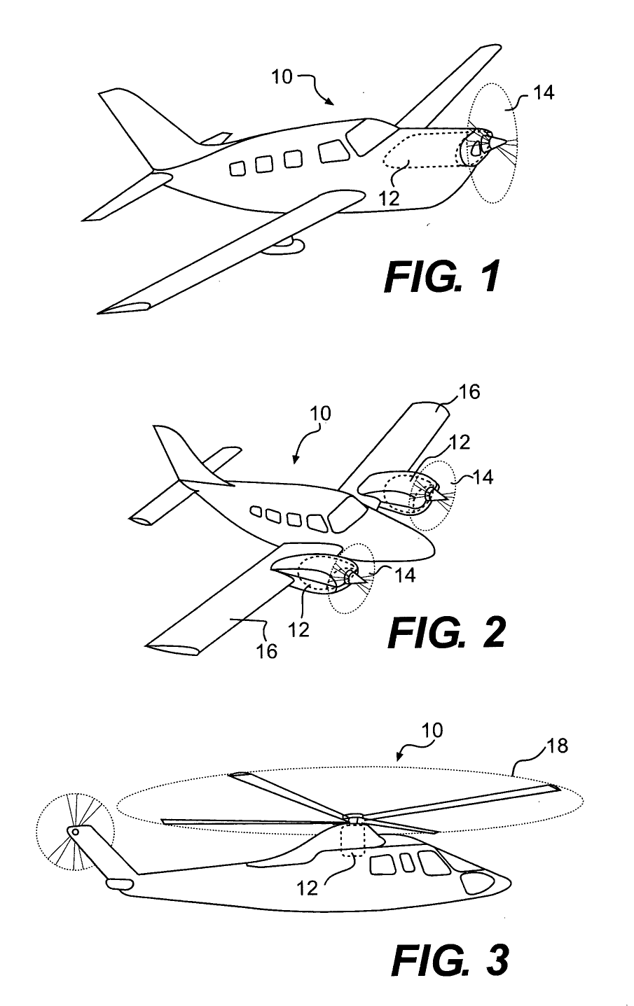

FIGS. 1-3 illustrate exemplary vehicles 10, for example, air vehicles, including exemplary embodiments of power train 12 for supplying power to a propulsion member 14. For example, FIG. 1 depicts an exemplary airplane having a single exemplary power train 12 for supplying power to a propeller 14. FIG. 2 depicts an exemplary airplane 10 having two exemplary power trains 12, each provided on wings 16 located on opposite sides of the airplane 10 for supplying power to corresponding propellers 14. FIG. 3 depicts an exemplary rotary-wing air vehicle 10 (i.e., a helicopter) having a single exemplary power train 12 for supplying power to rotor blades 18.

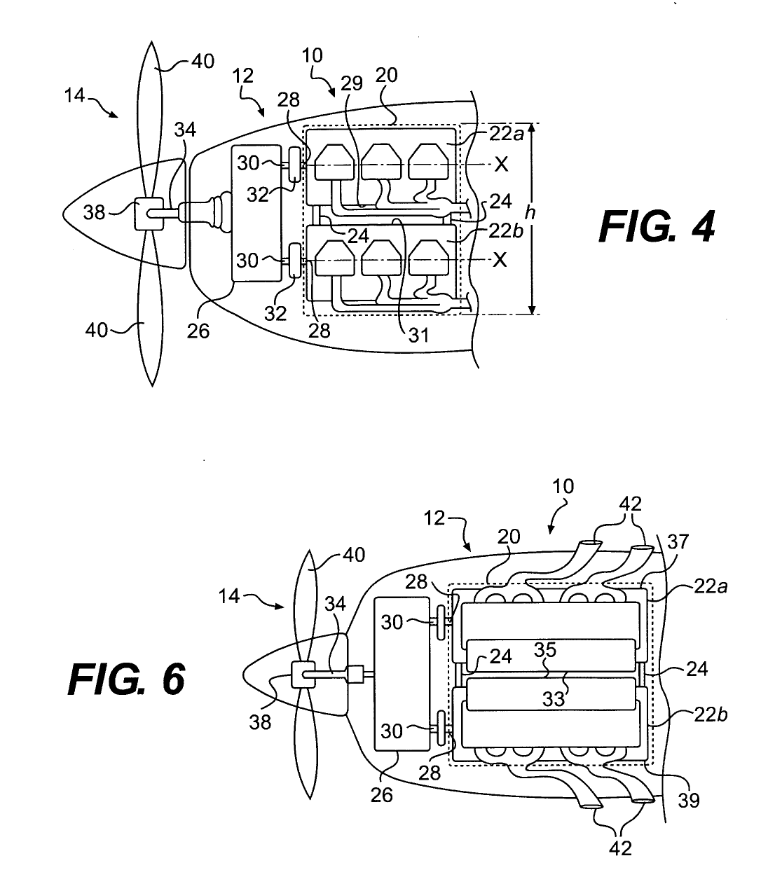

FIG. 4 schematically depicts a partial elevation view of an exemplary vehicle 10, including an exemplary power train 12. The exemplary power train 12 includes power module 20. The power module 20 includes two power sources 22 (some exemplary embodiments may be described as having two power sources 22a and 22b). According to some embodiments, the power module 20 may include more than two power sources 22. As shown in the exemplary embodiment depicted in FIG. 4, the two power sources 22 are associated with one another to form the power module 20. For example, the two power sources 22 may be operably coupled to one another via one or more coupling members 24, such that the power sources 22 form a unitary assembly. The two power sources 22 may be coupled to one another, for example, such that the longitudinal axes X of the power sources 22 are substantially parallel to one another. For example, as depicted in FIG. 4, the power sources 22 are arranged such that the longitudinal axis X of one power source is substantially parallel to the longitudinal axis X of the other power source 22.

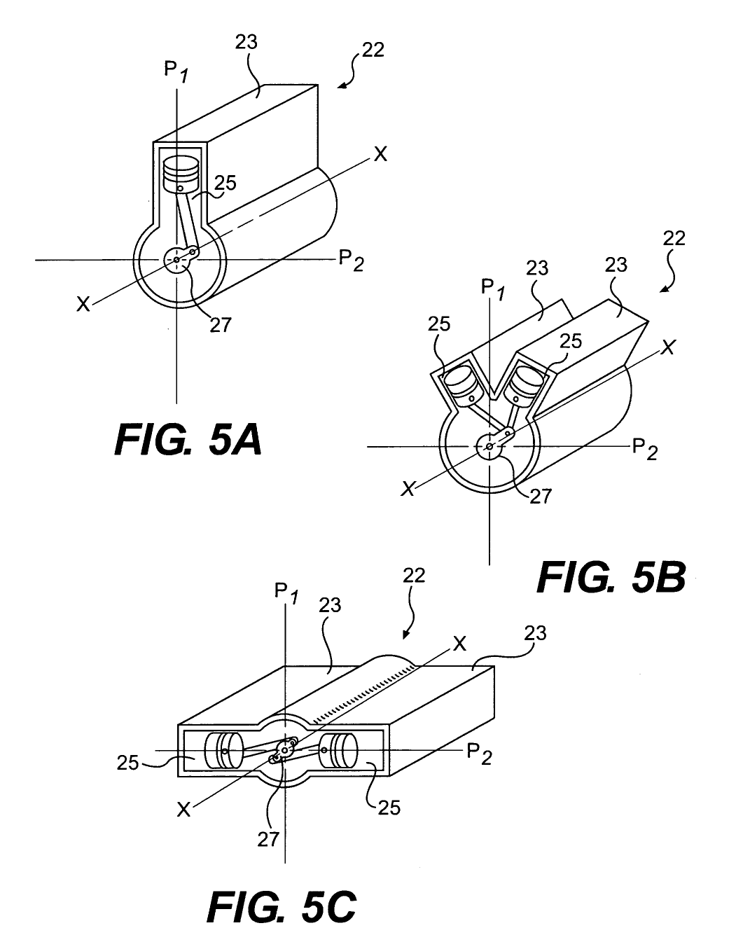

The power sources 22 may be arranged in a number of relative orientations. Referring to FIGS. 5A-5C, the power sources 22 may be reciprocating, piston-driven engines. For example, the exemplary power source 22 shown in FIG. 5A is an “in-line” configuration, including a single bank 23 of aligned cylinders 25 associated with a crankshaft 27. The crankshaft 27 defines a longitudinal axis X. According to some embodiments, a plane of symmetry with respect to the cylinders 25 (e.g., represented by line P₁ and containing the longitudinal axis X) may be defined. A second plane may be defined, for example, by line P₂ and may include the longitudinal axis X, the line P₂ being perpendicular to the line P₁, such that the plane of symmetry and the second plane are orthogonal with respect to one another. The exemplary power source 22 shown in FIG. 5B is a “V” configuration, including two banks 23 of aligned cylinders 25 associated with a crankshaft 27. The crankshaft 27 defines a longitudinal axis X. According to the exemplary embodiment shown in FIG. 5B, a plane of symmetry with respect to the two banks 23 of cylinders 25 (e.g., represented by line P₁ and containing the longitudinal axis X) may be defined. A second plane may be defined, for example, by line P₂ and may include the longitudinal axis X, the line P₂ being perpendicular to the line P₁, such that the plane of symmetry and the second plane are orthogonal with respect to one another. The exemplary power source 22 shown in FIG. 5C is a configuration sometimes referred to as a “horizontally-opposed” configuration, including two banks 23 of aligned cylinders 25 associated with a crankshaft 27, such that each of the two banks 23 of cylinders 25 are located on opposite sides of the crankshaft 27. According to the exemplary embodiment shown in FIG. 5C, a plane of symmetry with respect to the two banks 23 of cylinders 25 (e.g., represented by line P₁ and containing the longitudinal axis X) may be defined. A second plane may be defined, for example, by line P₂ and may include the longitudinal axis X, the line P₂ being perpendicular to the line P₁, such that the plane of symmetry and the second plane are orthogonal with respect to one another.

The power module 20 may be coupled to a transmission 26 via output shafts 28 associated with each of the power sources 22. For example, each of the output shafts 28 may be coupled to an input shaft 30 of the transmission 26 via a coupling member 32. One or more of the coupling members 32 may include, for example, a clutch (e.g., an overrunning clutch) and/or a vibration damping member configured to transfer torque from the output shafts 28 of the power sources 22 to the input shafts 30 of the transmission 26.

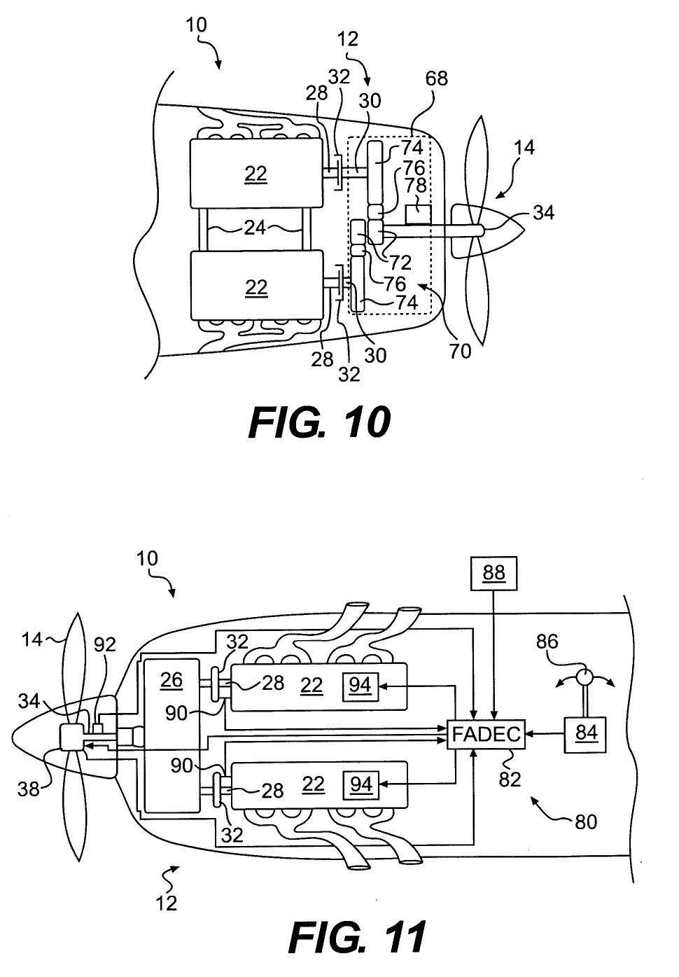

The transmission 26 may include gear assemblies (see, e.g., FIG. 10) for transferring power supplied by one or more of the power sources 22 via the input shafts 30 to a single propeller output shaft 34 of the transmission 26. In the exemplary embodiment depicted in FIG. 4, the single output shaft 34 is operably coupled to the propeller 14, such that the propeller 14 is driven to propel the exemplary airplane 10. The power train 12 may also be configured to control a pitch control device 38 configured to change the pitch of the blades 40 of the propeller 14.

According to some embodiments, the power module 20 may provide a wide range of available power to the vehicle 10. For example, by virtue of having two power sources 22, the power module 20 may be capable of supplying a higher peak power than a single power source might supply. The peak power might be desirable, for example, during operation of the vehicle 10 requiring a greater supply of power. Such operations might include the taking off and increasing altitude and/or speed of the vehicle 10 (i.e., when vehicle 10 is an airplane).

According to some embodiments, the power train 12 may be configured to supply an amount of power less than the peak power in an efficient manner. For example, when the vehicle 10 does not require peak power, the power train 12 may be configured to reduce or eliminate the power supplied from one or more of the power sources 22. Such a situation may occur, for example, when the vehicle 10 is an airplane that has reached a cruising altitude or is descending. In such situations, a clutch 32 selectively coupling the propeller output shaft 34 of one of the power sources 22 to an input shaft 30 of the transmission 26 may be configured to disconnect the transfer of power to the input shaft 30, such that only one of the power sources 22 is supplying power to the transmission 26. Further, one or more of the power sources 22 may be operated such that only a portion of the cylinders (i.e., when the power source 22 is a reciprocating piston-driven engine) operating to supply power. In a six-cylinder engine, for example, only three of the cylinders may be operating.

According to some embodiments, the power module 20 may be configured to supply power in the event that one of the power sources 22 is no longer operating. For example, if one of the power sources 22 experiences a malfunction that prevents it from being able to supply power to the power train 12, the power train 12 may be configured to operate using only one of the power sources 22 to supply power. For example, the clutch 32 associated with a power source 22 that is malfunctioning may be configured to disconnect the malfunctioning power source 22's output shaft 28 from the transmission 26's input shaft 30, such that only the operational power source 22 continues to supply power the transmission 26. In this manner, the vehicle 10 may be able to continue under power even though one of the power sources 22 is no longer operational. Such embodiments may be particularly beneficial when the vehicle 10 is an airplane or helicopter, where the ability to continue to supply power to the transmission 26 may enable the airplane or helicopter to land safely in spite of the malfunctioning of one of the power sources 22.

The power sources 22 may be the same or of similar configuration, or the power sources 22 may differ from one another. For example, the power sources 22 schematically-depicted in FIG. 4 are similar to one another. The power sources 22 may be any device that supplies power to a shaft. For example, the power sources 22 may be any internal combustion engine, such as, for example, spark-ignition engines, compression-ignition engines, four-stroke engines, two-stroke engines, reciprocating piston-driven engines, rotary engines, radial engines, and/or gas turbine engines. The power sources 22 may have any configuration known to those having ordinary skill in the art, such as, for example, in-line (see e.g., FIG. 5A), V (see e.g., FIG. 5B), W, H, horizontally-opposed (see, e.g., FIG. 5C), flat, and/or boxer configurations. The power sources 22 may have any number of cylinders. According to some embodiments, one or more of the power sources 22 may be supercharged via, for example, one or more turbochargers. According to some embodiments, one or more of the power sources 22 may be air-cooled and/or liquid-cooled. According to some embodiments, one or more of power sources 22 may be a motor, such as, for example, an electric motor (e.g., powered by one or more batteries), a hydrogen-powered motor, a fuel cell-powered motor, and/or a solar-powered motor.

The power sources 22 may define a length dimension defined in the direction of the longitudinal axis X (e.g., along the length of the crankshaft in an exemplary power source having a crankshaft), a height dimension perpendicular to the length dimension and defined by the upper portion and lower portion of the power source 22, and a width dimension perpendicular to the length dimension and the height dimension and defined by opposing sides of the power source 22.

According to some embodiments, the power sources 22 may include two engines, and the crankshafts of the two engines may rotate in opposite directions, for example, with the front end of both engines adjacent to one another, with the longitudinal axes X of the engines parallel to one another in the power module 20. According to some embodiments, the crankshafts may rotate in the same direction, with the front ends of both engines located adjacent to one another, with the longitudinal axes X of the engines parallel to one another in the power module 20. According to some embodiments, the power sources 22 may include two engines, and the two engines may be arranged such that the front end of one engine is adjacent to the rear end of the other engine, with the longitudinal axes X of the engines parallel to one another within the power module 20, and the crankshafts of the two engines may rotate either in the same direction or in different directions.

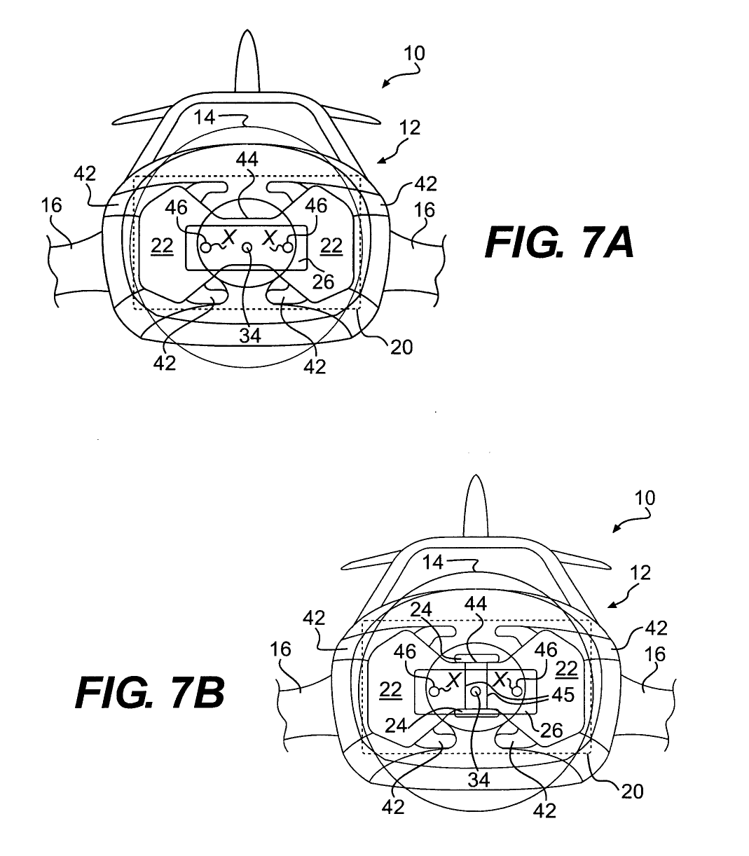

According to some embodiments, the power sources 22 may be oriented such that that one or more of the power sources 22 is not necessarily vertically oriented. For example, a plane of symmetry with respect to the cylinders 25 (see, e.g., FIGS. 5A-5C) may not necessarily be vertical. According to some embodiments, one or more of the power sources 22 may be revolved through an angle about the longitudinal axis X, such that the plane of symmetry is not vertical. For example, the exemplary embodiments schematically-depicted in FIGS. 7A and 7B show exemplary power modules 20 where the power sources 22 have been revolved about their respective longitudinal axes X through about 90 degrees in opposite directions, such that the bottom portions of the power sources 22 face one another and/or share components. The power sources 22 may be arranged such that either or both of the power sources 22 have been revolved at any angle ranging from about 0 degrees to about 360 degrees.

According to some embodiments, the power sources 22 may be arranged such that the power sources 22 are positioned one above the other. In the exemplary embodiment depicted in FIG. 4, for example, the power module 20 includes two horizontally-opposed, six-cylinder engines 22 arranged adjacent to one another and vertically with respect to one another, with the engines 22 oriented such that the cylinders of each of the engines 22 extend in substantially horizontal directions. For example, the lower surface 29 of the lower power source 22a faces the upper surface 31 of the lower power source 22b. In this exemplary arrangement, the power module 20 may take advantage of the relatively short height dimension generally inherent with horizontally-opposed engines, resulting in the power module 20 having a relatively compact overall height dimension h. According to some embodiments, the power sources 22 may be engines having other configurations (i.e., not horizontally-opposed and/or six-cylinder configurations) that are arranged vertically with respect to one another.

According to some embodiments, the power sources 22 may be arranged such that the power sources 22 are adjacent to one another in a side-by-side arrangement. For example, as depicted in the schematic, plan view of FIG. 6, the power module 20 may include, for example, two six-cylinder engines 22a and 22b having an in-line configuration. The power sources 22a and 22b may include exhaust systems 42 arranged such that that one or more of the exhaust systems 42 are located adjacent the exterior dimensions of the power module 20. For example, the power sources 22a and 22b may be arranged such that the right side 33 of the power source 22a (i.e., as viewed from the front of the vehicle 10) may be adjacent to the left side 35 of the power source 22b. The exhaust systems 42 may extend from the left side 37 of the power source 22a and the right side 39 of the power source 22b. According to some embodiments (not shown), the exhaust system 42 of one power source 22 may be located adjacent the exterior dimensions of the power module 20, and the exhaust system 42 of the other power source 22 may be located between the power sources 22. The exemplary arrangement of the power sources 22a and 22b shown in FIG. 6 may take advantage of generally narrow dimension inherent to engines having an in-line configuration. According to some embodiments, the power sources 22 may be engines having other configurations (i.e., not in-line and/or six-cylinder configurations) that are arranged horizontally with respect to one another as shown, for example, in FIG. 7A, which schematically-depicts two exemplary engines 22 having a V configuration.

According to some embodiments, the power sources 22 may be arranged such that the longitudinal axes X are offset from one another vertically and/or horizontally (not shown). Alternatively, or in addition, the power sources 22 may be arranged such that the front end and/or rear end of the power sources 22 are offset in the direction of the longitudinal axis X.

According to some embodiments, the power sources 22 may share one or more components. For example, as schematically-depicted in FIG. 7A, the power module 20 includes two engines 22, each having a V configuration. The two engines 22 are joined by a common crankcase 44, with the banks of cylinders extending obliquely toward the exterior dimension of the power module 20 (i.e., the two power sources 22 have been revolved about their respective longitudinal axes X about 90 degrees in opposite directions). Although shown in FIG. 7A as having crankshafts 46 aligned horizontally such that the engines have bi-lateral symmetry when viewed in the direction of the longitudinal axis of the vehicle 10, the two engines 22 may be arranged at different orientations with respect to one another (i.e., such that the Vs defined by the engines 22 do not have bi-lateral symmetry when viewed in the direction of the longitudinal axis of the vehicle 10). According to some embodiments, the engines 22 may include exhaust systems 42 extending from the exterior dimensions of the power module 22. According to some embodiments, one or more of the power sources 22 may be an engine having a configuration other than a V configuration (e.g., one or more horizontally-opposed engines), with the engines 22 sharing one or more components. According to some embodiments, the power sources 22 may share one or more of a crankcase, an engine block, a cooling system, a lubrication system, a fueling system, a control system, an intake system, a supercharging system, an exhaust system, and an ignition system.

According to some embodiments, the power sources 22 and the transmission 26 may share lubrication and/or cooling systems. According to some embodiments, the transmission 26 may have an independent lubrication and/or cooling system.

According to some embodiments, for example, as schematically-depicted in FIG. 7B, the power module 20 includes two engines 22 oriented such that the oil pan 45 of each engine 22 is adjacent to and facing the oil pan 45 of the other engine 22 (i.e., the two power sources 22 have been revolved about their respective longitudinal axes X about 90 degrees in opposite directions). The two engines 22 may be operably coupled to one another via one or more coupling members 24, with the banks of cylinders extending obliquely toward the exterior dimension of the power module 20. Although shown in FIG. 7B as having crankshafts 46 aligned horizontally such that the engines have bi-lateral symmetry when viewed in the direction of the longitudinal axis of the vehicle 10, the two engines 22 may be arranged such that they have different orientations with respect to one another (i.e., such that the Vs defined by the engines 22 do not have bi-lateral symmetry when viewed in the direction of the longitudinal axis of the vehicle 10). According to some embodiments, the engines 22 may include exhaust systems 42 extending from the exterior dimensions of the power module 22. According to some embodiments, one or more of the power sources 22 may be an engine having a configuration other than a V configuration (e.g., one or more a horizontally-opposed engine), with the oil pans of the engines 22 facing one another.

According to some embodiments, the power module 20 may have any orientation within the vehicle 10. For example, the power module 20 may be oriented in the vehicle 10 such that the longitudinal axes of the power sources are generally parallel to the longitudinal axis of the vehicle 10. According to some embodiments, the power module 20 may be oriented in the vehicle 10 such that the longitudinal axes of the power sources 22 are generally perpendicular to a longitudinal axis the vehicle 10 (see, e.g., FIG. 3 (i.e., the exemplary helicopter 10 may include a power train 12 having a power module 20 oriented such that the longitudinal axes of the power sources 20 extends generally vertically when the helicopter is level)).

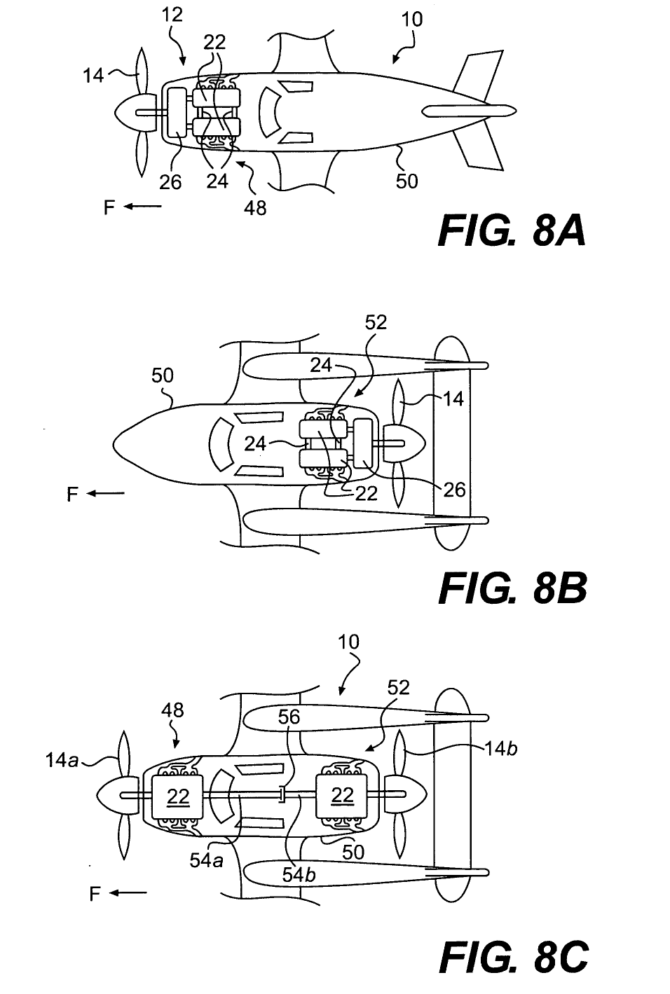

The power train 12 may be arranged in the vehicle 10 in a number of locations and/or orientations. For example, as depicted in FIG. 8A, an exemplary power train 12 is located in the front portion 48 of the fuselage 50 on an airplane 10, such that the propeller 14 pulls the airplane 10 in the forward direction F. The exemplary engines 22 depicted are in-line, six-cylinder engines, but other engine configurations and/or other types of power sources are contemplated. In the exemplary embodiment depicted in FIG. 8B, the exemplary power train 12 is located in a rear portion 52 of the fuselage 50 of the airplane 10, such that propeller 14 pushes the airplane 10 in the forward direction F. The exemplary engines 22 depicted are in-line, six-cylinder engines, but other engine configurations and/or other types of power sources are contemplated.

In the exemplary embodiment depicted in FIG. 8C, the exemplary power train 12 includes two engines 22, one engine 22 located in the front portion 48 of the fuselage 50 and one engine 22 located in the rear portion 52 of the fuselage, such that the propeller 14 associated with the engine 22 in the front portion 48 pulls the airplane 10 in the forward direction F, and/or the propeller 14 associated with the engine 22 located in the rear portion 52 pushes the airplane 10 in the forward direction F. The two engines 22 may be operably coupled via output shafts 54a and 54b, which may be selectively coupled to one another via a clutch 56. According to some embodiments, the engines 22 may be operated independently from one another or in combination, such that one of the engines 22 supplements power supplied by the other of the engines 22. The exemplary engines 22 depicted are horizontally-opposed, six-cylinder engines, but other engine configurations and/or other types of power sources are contemplated.

According to some embodiments (not shown), the power train 12 may be configured such that the power sources 22 supply power to two concentrically-arranged propeller output shafts 34 that supply power to two axially-arranged, counter-rotating propellers 14. According to this exemplary embodiment, each power source 22 may be operably coupled to a respective one of the concentrically-arranged propeller output shafts 34 such that the propeller output shafts 34 rotate in opposite directions. According to some embodiments, the counter-rotating propeller output shafts 34 may not be necessarily coupled to the corresponding power sources 22 via a clutch or clutches. An example of a vehicle having concentrically-arranged propeller output shafts coupled to two counter-rotating propellers is a “Fisher P-75 Eagle,” manufactured in prototype form by General Motors Corp. in the 1940s.

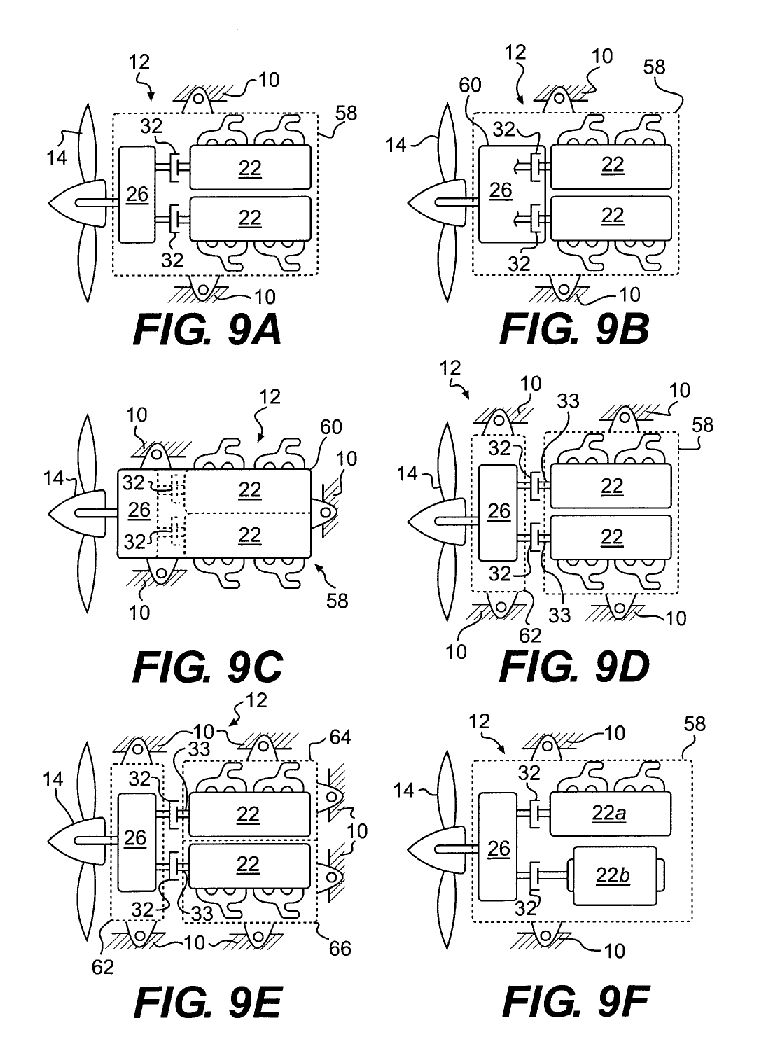

The power train 12 may be mounted in the vehicle 10 according to a number of differing mounting configurations. For example, exemplary embodiments of power train 12 may be mounted in the exemplary mounting configurations schematically-depicted in FIGS. 9A-9F.

For example, as shown in FIG. 9A, the power sources 22 and transmission 26 may be configured to be mounted as a single, unitary assembly 58. For example, the assembly 58 may be operably coupled the vehicle 10 (e.g., to the frame of the vehicle 10). According to some embodiments, the clutches 32 may not be housed within the same housing as the transmission 26, as shown in FIG. 9A. The exemplary power sources 22 shown in FIG. 9A are in-line, six-cylinder engines, but other engine configurations and/or other types of power sources are contemplated.

According to the exemplary embodiment shown in FIG. 9B, the power sources 22 and transmission 26 may be configured to be mounted as a single, unitary assembly 58. For example, the assembly 58 may be operably coupled the vehicle 10 (e.g., to the frame of the vehicle 10). According to some embodiments, the transmission 26 and the clutches 32 may be housed within a single housing 60, as shown in FIG. 9B. The exemplary power sources 22 shown in FIG. 9B are in-line, six-cylinder engines, but other engine configurations and/or other types of power sources are contemplated.

According to the exemplary embodiment shown in FIG. 9C, the power sources 22, the clutches 32, and the transmission 26 may be coupled to one another (e.g., they may be housed within the same housing 60) to form a single, unitary assembly 58. The assembly 58 may be operably coupled to the vehicle 10 (e.g., to the frame of the vehicle 10). The exemplary power sources 22 shown in FIG. 9C are in-line, six-cylinder engines, but other engine configurations and/or other types of power sources are contemplated.

According to some embodiments, the power sources 22 and the transmission 26 may not be coupled to one another. For example, as shown in FIG. 9D, the power sources 22 are coupled to one another and form a single, unitary assembly 58, and the transmission 26 forms a single, unitary assembly 62. Each of the assemblies 58 and 62 is separately coupled to the vehicle 10 (e.g., to the frame of vehicle 10). According to some embodiments, a flexible coupling 33 may be associated with, for example, one or more of the output shafts 28 of the power sources 22. The flexible coupling(s) 33 may be configured to compensate for independent motion of the assemblies 58 and 62. The exemplary power sources 22 shown in FIG. 9D are in-line, six-cylinder engines, but other engine configurations and/or other types of power sources are contemplated.

According to some embodiments, for example, as shown in FIG. 9E, the power sources 22 are not coupled to one another and form two assemblies 64 and 66 for mounting in the vehicle 10. The transmission 26 forms a single, unitary assembly 62, and the two power source assemblies 64 and 66 and the transmission assembly 62 are operably coupled to the vehicle 10 (e.g., the vehicle 10's frame). According to some embodiments, a flexible coupling 33 may be associated with, for example, one or more of the output shafts 28 of the power sources 22. The flexible coupling(s) 33 may be configured to compensate for independent motion of the assemblies 62, 64 and/or 66. The exemplary power sources 22 shown in FIG. 9E are in-line, six-cylinder engines, but other engine configurations and/or other types of power sources are contemplated.

According to some embodiments, the power sources 22 may differ. For example, as shown in the exemplary embodiment depicted in FIG. 9F, one power source 22a may be an engine (e.g., an in-line, six-cylinder engine) and the power source 22b may be a motor, for example, an electric motor supplied with electric power by one or more fuel cells, solar cells, and/or batteries. According to some embodiments, the power source 22a, power source 22b, and transmission 26 may be coupled to one another to form a single, unitary assembly 58, which may be mounted to the vehicle 10 (e.g., the frame of the vehicle 10). The exemplary power source 22a shown in FIG. 9F is an in-line, six-cylinder engine, but other engine configurations and/or other types of power sources are contemplated.

FIG. 10 schematically-depicts an exemplary embodiment of the power train 12. For example, the transmission 26 includes a transmission housing 68 configured to enclose a gear assembly 70 for transferring power from the power sources 22 to the propeller output shaft 34, which drives the propeller 14. The power sources 22 include output shafts 28 that may be operably coupled to the input shafts 30 of the transmission 26 via clutches 32, which may be engaged and disengaged. According to some embodiments, one or more of the clutches 32 may be overrunning clutches or one-way clutches that permit either transfer of power to the transmission 26's input shaft 30 or allows the transmission input shaft 30 to rotate independently of the power source 22's output shaft 28. For example, one or more of the clutches 32 may be a ball-bearing type clutch, or any other type of clutch known to those having ordinary skill in the art. Some embodiments of the power train 12 may include one or more vibration damper assemblies that may either be incorporated into the clutch(es) 32, or be separate from the clutches. The vibration damper assembl(ies) may be configured, for example, to reduce the transfer of vibration and/or torque spikes from the power sources 22 to the propeller output shaft 34 that may result from, for example, the misfiring of one or more of the power sources 22. According to some embodiments, the vibration damper assembly may be similar to an automotive vibration damper and may include, for example, internal springs configured to absorb torque spikes. Other vibration dampers known to those having skill in the art may be used.

According to some embodiments, the gear assembly 70 includes two drive gears 72 operably coupled along the length of the propeller output shaft 34. According to some embodiments, the clutches 32 and/or vibration dampers may be incorporated into the drive gears 72 to form a unitary assembly. An input gear 74 is operably coupled to each of the transmission input shafts 30, such that the input gears 74 are not longitudinally-aligned within the transmission housing 68. The input gears 74 may not be longitudinally-aligned by virtue of the input shafts having differing lengths and/or by virtue of the power sources being longitudinally-offset from one another. According to some embodiments, the input gears 74 transfer power to the propeller output shaft 34 via idler gears 76 engaged with each of the input gears 72.

According to some embodiments, for example, as schematically-depicted in FIG. 10, the power train 12 may include a drive propeller governor 78, which may be located in the transmission housing 68. The governor 78 may be configured to control the pitch of the propeller blades 40 of an airplane or the rotor blades 18 of a helicopter. For example, the governor 78 may be driven by the gear assembly 70 and may supply pressurized lubrication drawn from the transmission 26 to a propeller pitch control device (e.g., pitch control device 38) or a rotor blade pitch control device (not shown) in order to control the pitch of the propeller blades or rotor blades.

According to some embodiments, for example, as schematically-depicted in FIG. 11, the power train 12 may include a control system 80 configured to control operation of the power train 12. For example, the control system 80 may include a full-authority digital engine control (FADEC) system 82 and a single lever power control (SLPC) system 84. The FADEC system 82 and/or SLPC system 84 may be configured to enable an operator of the vehicle 10 to control operation of the power train 12 via the movement of a single operator control device 86 (e.g., a single control lever). For example, movement of the control device 86 may result in operation of the two power sources 22, clutches 32, transmission 26, and/or pitch control device 38, such that the power train 12 operates according to the operator's movement of the control device 86 and/or the ambient conditions and/or vehicle speed. Other exemplary embodiments described and schematically depicted herein may include a control system, for example, a control system that may include a FADEC system and/or an SLPC system.

According to some embodiments, the FADEC system 82 may be configured to receive signals from the SLPC system 84 and one more sensors 88 configured to generate signals indicative of ambient air conditions (e.g., temperature and/or pressure) and/or vehicle speed (e.g., air speed). According to some embodiments the FADEC system 82 may be configured to receive signals indicative of the operation of the power sources 22 (e.g., engine speed and/or load), for example, via sensors 90, signals indicative of the speed and/or load of the propeller output shaft 34 via sensor 92, and/or signals indicative of the operation of the pitch control device 38 (e.g., the propeller pitch). Based on one or more of the signals, the FADEC system 82 may send signals to each of the power sources 22 (e.g., to power source controllers 94 (e.g., throttle and/or ignition devices)) and/or the pitch control device 38, such that the power train 12 operates according to the operator's movement of the control device 86 and/or the ambient conditions and/or vehicle speed. Such an exemplary control system 80 may result in easier operation of the power train 12. For example, such a control system 80 may result in the ability of a less experienced operator, or an operator having less skill, to operate the power train 12, even though it has two power sources 22 that might ordinarily require two sets of independent controls for operation.

During operation, according to some embodiments of the power train 12, the power train 12 may provide the benefits of a multi-engine vehicle, while providing the ease of operation that may often be associated with a single engine vehicle. For example, in an airplane, exemplary embodiments of the power train 12 may exhibit a number of potential benefits, such as, for example, a higher peak power level than the peak power level that may be available with a single engine. Some embodiments of the power train 12 may also continue to provide enough power to continue flying in the event, for example, that one of the power sources 22 malfunctions or discontinues operating. The non-malfunctioning power source 22 may provide the airplane with sufficient power to continue flying until the airplane may be safely landed. By virtue of the power sources 22 being operably coupled to the transmission 26 via clutches 32 (according to some embodiments), the transmission 26's transfer of power to the propeller output shaft 34 may be substantially unaffected, regardless of whether one of the engines 22 is operating.

According to some embodiments, the power train 12 may provide the ability to provide the vehicle 10 with a high peak power when desired and also provide efficiency when peak power is not desired. For example, if the vehicle 10 is an airplane, it may be desirable to have a relatively high peak power when taking off, climbing, and/or increasing speed. On the other hand, it may be desirable to operate efficiently when the airplane is cruising during level or descending flight. During such times, some embodiments of the power train 12 may be configured to reduce fuel consumption by, for example, reducing the power output and/or shutting down one of the power sources 22. For example, one or more of the power sources 22 may be operated such that one or more of the cylinders (i.e., when one or more of the power sources 22 is a reciprocating, piston-driven engine) discontinues operating and/or the ignition timing is altered. According to some embodiments, one or more of the power sources 22 may be shut down completely until, for example, more power is desired. By virtue of the power sources 22 being operably coupled to the transmission 26 via clutches 32 according to some embodiments, the transmission 26's transfer of power to the propeller output shaft 34 may be substantially unaffected, regardless of whether one of the power sources 22 is operating. The FADEC system 82 and/or SLPC system 84 may facilitate such operations, according to some embodiments.

The power train 12, according to some embodiments, may result in a number of benefits associated with the vehicle 10. For example, in an airplane, the cross-section of the tail may be reduced due to orienting two power sources adjacent to one another. Orienting the two power sources 22 adjacent one another may permit the airplane to have a shorter longitudinal axis relative to other fuselage-mounted, multiple-propulsion systems. This, in turn, may permit a reduction in the size (e.g., cross-section) of the tail while maintaining acceptable stability and control of the airplane, which may result in reduced drag, weight, operating costs, and/or manufacturing costs.

It will be apparent to those skilled in the art that various modifications and variations can be made to the structures and methodologies described herein. Thus, it should be understood that the invention is not limited to the subject matter discussed in the specification. Rather, the present invention is intended to cover modifications and variations.

What is claimed is:

1. A power train for a vehicle, the power train comprising:
at least two power sources configured to supply power for propelling the vehicle, each of the power sources comprising a power source output shaft;
a transmission comprising
at least two transmission input shafts operably coupled to the at least two power source output shafts, and
a single transmission output shaft configured to supply power to a propulsion member; and
a controller configured to control operation of the at least two power sources, the controller comprising a full-authority digital electronic controller (FADEC).

2. The power train of claim 1, further comprising a single lever power controller (SLPC) configured to provide simultaneous control of the power sources.

3. The power train of claim 1, wherein each of the power sources are operably coupled to the transmission via respective clutches configured to permit the power sources to supply power to the transmission output shaft independently from one another.

4. The power train of claim 1, wherein the at least two power sources share at least one of a crankcase, an engine block, a cooling system, a lubrication system, a fueling system, an intake system, a supercharging system, an exhaust system, and an ignition system.

5. The power train of claim 1, wherein at least one of the power sources comprises an internal combustion engine.

6. The power train of claim 1, wherein the at least two power sources each comprise an engine block, and the engine block of one of the power sources is separate from the engine block of another of the power sources.

7. The power train of claim 1, further comprising a vibration damping system configured to substantially prevent the transfer of vibrations from the power source output shafts to the single transmission output shaft.

8. The power train of claim 1, wherein a first one of the power sources is positioned above a second one of the power sources.

9. The power train of claim 1, wherein each of the power sources comprises an internal combustion engines having an oil pan, wherein the power sources are oriented with respect to one another such that the oil pans face one another.

10. The power train of claim 1, wherein each of the power sources comprises an internal combustion engine defining a crankcase, and the internal combustion engines are joined at the crankcases.

11. The power train of claim 1, wherein each of the power source output shafts defines a longitudinal axis,
wherein each of the power sources defines a respective plane of symmetry with respect to the respective cylinders of each power source,
wherein each of the power sources defines a respective second plane that includes the longitudinal axis and extends in a direction perpendicular to the first plane, and
wherein at least one of
the first plane defined by one of the power sources is coplanar with the first plane defined by another of the power sources,
the first plane defined by one of the power sources intersects the first plane defined by another of the power sources, and
the second plane defined by one of the power sources and the second plane defined by another of the power sources are parallel and spaced from one another.

12. A power train for a vehicle, the power train comprising:
at least two power sources operably coupled to one another to form a unitary structure, the at least two power sources being configured to supply power for propelling the vehicle, each of the power sources comprising a power source output shaft and a plurality of cylinders;
a transmission comprising
at least two transmission inputs operably coupled to the at least two power source output shafts, and
a single transmission output shaft configured to supply power to a propulsion member,
wherein the transmission is configured to combine power supplied by the at least two power sources via the power source output shafts into the single transmission output shaft; and
a propulsion member configured to propel the vehicle,
wherein each of the power source output shafts defines a longitudinal axis,
wherein each of the power sources defines a respective plane of symmetry with respect to the respective cylinders of each power source,
wherein each of the power sources defines a respective second plane that includes the longitudinal axis and extends in a direction perpendicular to the first plane, and
wherein at least one of
the first plane defined by one of the power sources is coplanar with the first plane defined by another of the power sources,
the first plane defined by one of the power sources intersects the first plane defined by another of the power sources, and
the second plane defined by one of the power sources and the second plane defined by another of the power sources are parallel and spaced from one another.

13. The power train of claim 12, wherein the longitudinal axis of one of the power sources is substantially parallel to the longitudinal axis of another of the power sources.

14. The power train of claim 12, wherein the first plane defined by one of the power sources intersects the first plane defined by another of the power sources.

15. The power train of claim 12, wherein the first plane defined by one of the power sources is substantially coplanar with the first plane defined by another of the power sources, and the second plane defined by one of the power sources and the second plane defined by another of the power sources are parallel and spaced from one another.

16. The power train of claim 12, wherein at least one of the power sources is operably coupled to the transmission via a clutch configured to permit the power sources to supply power to the transmission output shaft independently from one another.

17. The power train of claim 12, wherein at least one of the power sources is supercharged.

18. The power train of claim 12, wherein the at least two power sources share at least one of a crankcase, an engine block, a cooling system, a lubrication system, a fueling system, a control system, an intake system, a supercharging system, an exhaust system, and an ignition system.

19. The power train of claim 12, wherein at least one of the power sources is at least one of air-cooled and liquid-cooled.

20. The power train of claim 12, wherein at least one of the power sources comprises an internal combustion engine.

21. The power train of claim 12, wherein the at least two power sources each comprise an engine block, and the engine block of one of the power sources is separate from the engine block of another of the power sources.

22. The power train of claim 12, further comprising a full-authority digital control (FADEC) system configured to control the power sources independently from one another.

23. The power train of claim 12, further comprising a single lever power controller (SLPC) configured to provide simultaneous control of the power sources.

24. The power train of claim 12, further comprising a vibration damping system configured to substantially prevent the transfer of vibrations from the power source output shafts to the single transmission output shaft.

25. The power train of claim 12, further comprising a lubrication system configured to provide lubrication to the transmission independent from the power sources.

26. The power train of claim 12, wherein the propulsion member comprises a propeller having blades with adjustable pitch, wherein the transmission comprises a pitch control device configured to control the pitch of the blades.

27. The power train of claim 12, wherein the transmission and the at least two power sources form a unitary structure, and the unitary structure is configured to be mounted in the vehicle as a unitary structure.

28. The power train of claim 12, wherein the at least two power sources form a power module, wherein the transmission and the power module are configured to be mounted in the vehicle separately from one another.

29. The power train of claim 12, wherein the power sources are configured to be mounted in the vehicle such that the longitudinal axes are substantially horizontal.

30. The power train of claim 12, wherein the power sources are configured to be mounted in the vehicle such that the longitudinal axes are substantially vertical.

31. The power train of claim 12, wherein a first one of the power sources is positioned above a second one of the power sources.

32. The power train of claim 12, wherein each of the power sources comprises an internal combustion engines having an oil pan, wherein the power sources are oriented with respect to one another such that the oil pans face one another.

33. The power train of claim 12, wherein each of the power sources comprises an internal combustion engine having a crankcase, and the internal combustion engines are joined at the crankcases.

34. A vehicle comprising:
a propulsion member; and
a power train comprising
at least two power sources, the at least two power sources configured to supply power for propelling the vehicle, each of the power sources comprising a power source output shaft,
a transmission comprising
at least two transmission inputs operably coupled to the at least two power source output shafts, and
a single transmission output shaft operably coupled to the propulsion member and configured to supply power to the propulsion member,
wherein the transmission is configured to combine power supplied by the at least two power sources via the power source output shafts into the single transmission output shaft, and
a controller configured to control operation of the at least two power sources, the controller comprising a full-authority digital electronic controller (FADEC).

35. The vehicle of claim 34, wherein the vehicle comprises an air vehicle.

36. The vehicle of claim 34, wherein the vehicle comprises an airplane.

37. The vehicle of claim 36, wherein the propulsion member comprises a propeller operably coupled to the single transmission output shaft.

38. The vehicle of claim 36, wherein the airplane comprises at least two of the power trains and a propeller operably coupled to each of the single transmission output shafts of the at least two power trains.

39. The vehicle of claim 34, wherein the vehicle comprises a helicopter.
